(19) United States
(12) Patent Application Publication
(10) Pub. No.: US 2011/0198512 A1
(43) Pub. Date: Aug. 18, 2011

(54) CHARGED CORPUSCULAR BEAM APPARATUS

(75) Inventors: Koki Miyahara, Hitachinaka (JP); Katsuya Kawakami, Mito (JP); Masahiro Tsunoda, Hitachinaka (JP); Takashi Gunji, Mito (JP)

(73) Assignee: Hitachi High-Technologies Corporation

(21) Appl. No.: 13/125,586

(22) PCT Filed: Oct. 15, 2009
(86) PCT No.: PCT/JP2009/005373

§ 371 Date: Apr. 22, 2011

(30) Foreign Application Priority Data
Oct. 24, 2008 (JP) 2008-273715

(51) Int. Cl. G21K 5/08

(52) U.S. Cl. 250/442.11

(57) ABSTRACT

An object of the invention is to provide a charged corpuscular beam apparatus which is equipped with a static elimination mechanism suitable for eliminating electric charges deposited on front and back surfaces of a specimen. To achieve the foregoing object, there is proposed a static elimination mechanism which includes a first ionizer for eliminating electric charges from the front surface of the specimen, and a second ionizer for eliminating electric charges from the back surface of the specimen. The first and second ionizers are disposed in a mini-environment, and are arranged along a downflow in the mini-environment. A specimen carrying mechanism is disposed so that the specimen can pass between the two ionizers.

### TECHNICAL FIELD

The present invention relates to a charged corpuscular beam apparatus. Particularly, it relates to an apparatus in which a specimen is conveyed into a charged corpuscular beam apparatus after electric charges are eliminated from the specimen by a static elimination mechanism.

### BACKGROUND ART

A charged corpuscular beam apparatus (charged particle microscope) represented by a scanning electron microscope (SEM) has been known as an apparatus for measuring and inspecting a specimen used for manufacturing a semiconductor. In such an apparatus that narrows down a charged corpuscular beam to scan a specimen with the charged corpuscular beam, it may be difficult for the apparatus to properly perform optical condition adjustment (e.g. focusing adjustment) when electric charges are deposited on the specimen.

A case where electric charges are deposited on a specimen in a semiconductor manufacturing process, a specimen conveyance path, or the like, has been found occasionally in accordance with recent change in material used in semiconductor devices. There is a possibility that the presence of such electric charges will cause defocusing etc. to thereby bring a factor of lowering of throughput etc. in a process of measuring and inspecting the specimen with an SEM, etc. A static elimination mechanism using ionizers for eliminating electric charges from a specimen before introduction of the specimen into an inspection apparatus such as an SEM has been described In Patent Literature 1.

An example in which a substrate conveyance robot for conveying a substrate is disposed in a space in which a downflow of a filter fan unit (FFU) is formed, in a processing portion for processing the substrate and ionizers are provided in an upper portion of the conveyance robot so that ions can be supplied to the substrate efficiently has been described in Patent Literature 2.

### CITATION LIST

### Patent Literatures

Patent Literature 1: U.S. Pat. No. 6,507,474
Patent Literature 2: JP-A-2005-044975

### SUMMARY OF INVENTION

### Technical Problem

In a semiconductor device, a photomask is provided with a shield pattern of a chrome film which is formed on a quartz substrate so as to correspond to a circuit design pattern. As for such a specimen, electric charges may be deposited not only on the front surface (upper surface) of the specimen but also on the back surface of the specimen. Since all the back surface of the photomask is made of an insulator, larger electric charges than those deposited on the front surface of the specimen may be deposited on the back surface of the specimen. According to disclosure of Patent Literature 1, there is description in the viewpoint that two or more ionizers are used for eliminating static electricity from the specimen but there is no description in the viewpoint that two or more ionizers are used for eliminating static electricity from the back surface of the specimen.

Also in Patent Literature 2, there is no description in the viewpoint that static electricity is eliminated from the back surface of the specimen.

A charged corpuscular beam apparatus provided with a static elimination mechanism particularly suitable for eliminating electric charges deposited on both front and back surfaces of a specimen will be described below.

### Solution to Problem

In order to eliminate electric charges deposited on both front and back surfaces of a specimen, there is proposed a static elimination mechanism including a first ionizer for eliminating static electricity from the front surface of the specimen, and a second ionizer for eliminating static electricity from the back surface of the specimen. The first and second ionizers are disposed in a mini-environment so as to be arranged along a downflow in the mini-environment. A specimen carrying mechanism is disposed so that the specimen passes between the two ionizers.

### Effect of Invention

According to the aforementioned configuration, orientation of ions with respect to a specimen using a downflow in the mini-environment can be performed for the front surface of the specimen and easy arrival of ions at the back surface of the specimen can be performed for the back surface of the specimen because the specimen serves as a shield member with respect to the downflow. Accordingly, elimination of static electricity from the front and back surfaces of the specimen can be achieved with high efficiency.

### BRIEF DESCRIPTION OF DRAWINGS

FIG. 1 A schematic configuration view (side view) of a CD-SEM.

FIG. 2 A schematic configuration view (top view) of the CD-SEM.

FIG. 3 A schematic configuration view (side view) of a specimen conveyance mechanism.

FIG. 4 A schematic configuration view (top view) of the specimen conveyance mechanism.

FIG. 5 A schematic configuration view of an ionizer.

FIG. 6 A view for explaining a state during irradiation of ions by ionizers.

FIG. 7 A flow chart for explaining a process of specimen conveyance and static elimination using ionizers.

FIG. 8 A view for explaining a robot hand of a conveyance robot.

FIG. 9 A flow chart for explaining a process of specimen conveyance and static elimination using ionizers.

FIG. 10 A flow chart for explaining a process of specimen conveyance and static elimination using ionizers.

### DESCRIPTION OF EMBODIMENTS

An electron microscope for measuring the length of a pattern on a photomask or a wafer in a semiconductor manufacturing and inspection site will be described below with reference to the drawings. In the description, an apparatus for monitoring a static elimination state of a photomask while eliminating electric charges from the photomask by using ionizers in a conveyance path of the photomask conveyed to a specimen chamber in order to measure the pattern of the photomask will be taken as an example.

As for a photomask used in semiconductor manufacturing or a wafer produced with use of the photomask, fineness of patterns formed therein has advanced with the recent advance of integration of circuits. A so-called CD-SEM (Critical Dimension-Scanning Electron Microscope) is used as a pattern size measuring device for measuring these patterns.

There may be a case where electric charges are deposited on the photomask or wafer to be measured in a process of manufacturing or conveying the photomask or wafer. In addition, whether electric charges are deposited or not, and the degree of electric charges vary according to a specimen keeping method.

Because electric charges deposited in the manufacturing process, etc. as described above have a bad influence on an electron or ion beam to be irradiated, there is a possibility that the electric charges will change an optical condition such as defocusing or variation in magnification and will consequently bring a factor of lowering of length measuring accuracy. There is a method using ionizers in order to eliminate such electric charges deposited on a specimen.

Particularly, a CD-SEM for measuring the length of a photomask will be described below with reference to the drawings. The photomask is charged easily. If the charged photomask is subjected to beam scanning, there is a possibility that the electric charges will make it difficult to adjust a beam condition or will exert a bad influence on a measurement result to thereby bring a cause of lowering of accuracy.

Although static elimination based on ion irradiation is a method for solving this problem, there may arise a case where foreign matters are generated due to abrasion of electrodes generating ions or it takes a considerable time for conveyance because the photomask during conveyance must be stopped for ion irradiation.

A scanning electron microscope and a method of eliminating static electricity from a specimen, in which ionizers are disposed in the vicinity of a photomask conveyance path so that static elimination using the ionizers is performed during conveyance and in which the amount of electric charges of a photomask is monitored so that electric charges can be suppressed effectively while the time of irradiation of ions from the ionizers can be suppressed, are proposed in the following embodiment.

### Embodiment

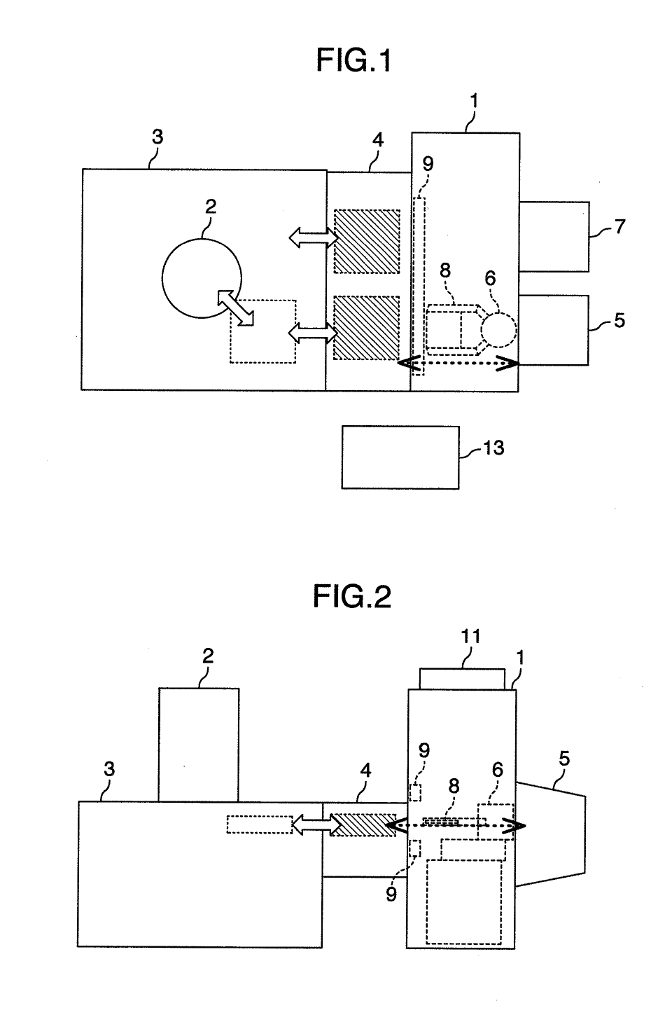

FIGS. 1 and 2 are views for schematically explaining an SEM used for measuring and inspecting a semiconductor device. Particularly, FIGS. 1 and 2 illustrate a CD-SEM (Critical Dimension-SEM) used for measuring dimensions of a pattern, as a kind of SEM used for measuring and inspecting a semiconductor device. A specimen observation chamber 3 is provided with a stage which moves a photomask 8 to be observed, accurately just under a column 2 which includes an electron gun and an electronic optical system. A detector which detects a secondary electron signal from the photomask 8 is provided in the column 2 so that the detector sends the secondary electron signal to a control device.

A load lock chamber 4 for keeping a vacuum state from the atmosphere in order to convey a specimen at a high speed for high vacuum observation is provided in front of the specimen observation chamber 3. The load lock chamber 4 is separated from the specimen observation chamber 3 and the outside air by gate valves respectively. An evacuation device is connected to the load lock chamber 4 and the specimen observation chamber 3 so that the load lock chamber 4 and the specimen observation chamber 3 are evacuated to a high vacuum enough for an electron beam to pass through the inside of each chamber.

A mechanism for conveying the photomask 8 to the load lock chamber 4 has a load port 7, a mask stocker 5, and a conveyance robot 6. Since the cleanliness level of a portion where the photomask 8 is conveyed needs to be enhanced locally, the whole of the mechanism is covered with a box-like substance called mini-environment 1. An FFU 11 is provided on the mini-environment 1 so that air with a high cleanliness level and under a more positive pressure than that of the outside is supplied to the mini-environment 1 through the FFU 11. An air cleaning mechanism made of such a mini-environment system is configured so that a state where air is introduced from the outside through a filter provided in the FFU is kept to make the inside air pressure relatively high compared with the outside. The FFU is disposed in an upper portion of the mini-environment so that air introduced through the FFU forms a downflow which moves down.

The respective constituent elements including a conveyance operation are controlled by a control portion 13 having a built-in computer. An operator issues an instruction to perform a conveyance operation by using a mouse, a keyboard or a user interface such as buttons on a screen of an LCD display which is a display device.

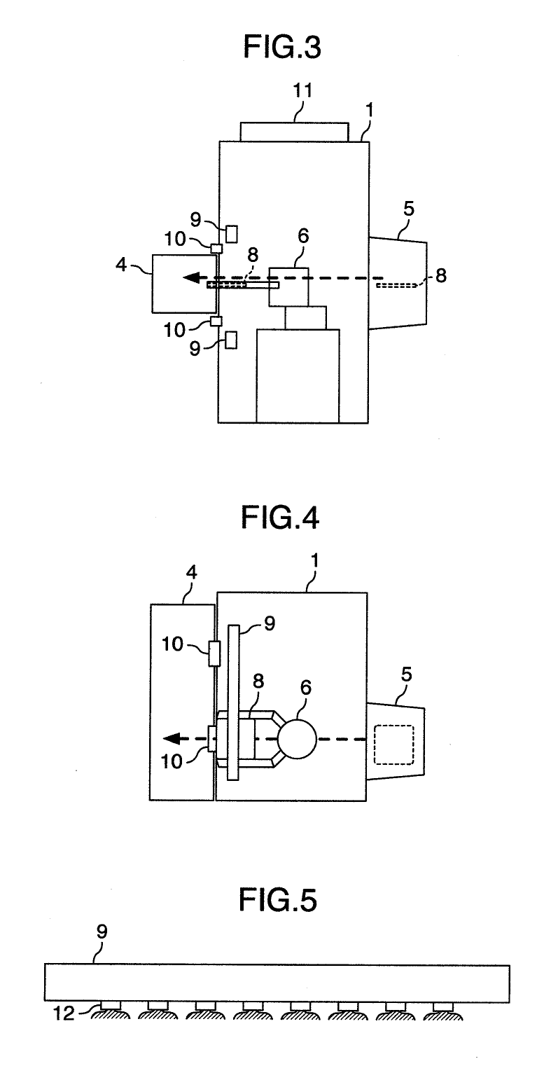

FIGS. 3 and 4 show a configuration for conveying the photomask 8 to the load lock chamber 4. The photomask 8 is conveyed from the mask stocker 5 to the load lock chamber 4 by the conveyance robot 6. This conveyance robot 6 has a structure in which the front and back surfaces of the photomask 8 are not covered with the conveyance robot 6 when the photomask 8 is held by the conveyance robot 6.

Static elimination devices (hereinafter referred to ionizers) 9 and surface potential sensors 10 for monitoring the amount of electric charges of the photomask 8 are provided in the conveyance path. The ionizers 9 and the surface potential sensors 10 are disposed above and below a conveyance track in order to eliminate electric charges from the front and back surfaces of the photomask 8 and monitor the amount of the electric charges.

FIG. 5 schematically shows an ionizer 9. The ionizer 9 has electrode needles 12 which generate ions. The electrode needles 12 have a function of generating and emitting plus and minus ions in accordance with the amount of electric charges of a substance (photomask 8) from which electric charges should be eliminated.

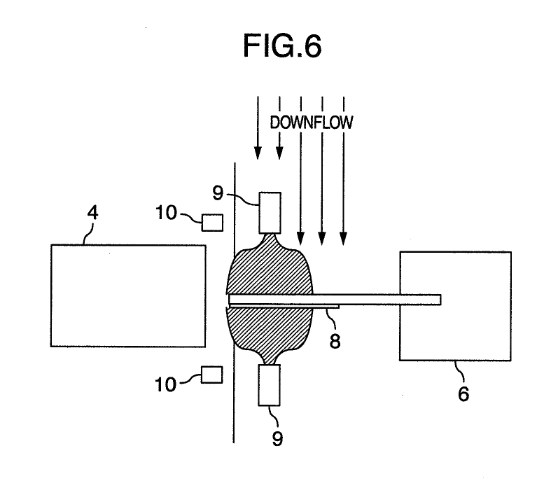

FIG. 6 shows a schematic view concerned with a method using the ionizers 9. The downflow in the mini-environment 1 during irradiation from the ionizers is used in the configuration shown in FIG. 6. Since ions generated by the upper ionizer 9 are accelerated due to the effect of the downflow in the mini-environment 1, it is possible to eliminate electric charges from the front surface of the photomask 8 without any air fed to the ionizer.

Moreover, the lower ionizer 9 is not affected by the downflow because the photomask is located just above the lower ionizer 9. Accordingly, ions can be blown up to the back surface of the photomask 8 by the lower ionizer 9. The back surface of the specimen is an insulator, so that the amount of electric charges deposited on the back surface of the specimen may be often larger than the amount of electric charges deposited on the front surface of the specimen where a pattern is formed. As described above, because the bad influence of the downflow on the lower ionizer can be eliminated as sufficiently as possible, the effect of static elimination on the back surface of the specimen can be enhanced to thereby consequently contribute to improvement in throughput of the apparatus as a whole.

As shown in FIG. 8, shield members 18 may be provided out of a passage track of a hand of the conveyance robot 6 and between the FFU and the lower ionizer in order to eliminate the bad influence of the downflow on the lower ionizer as sufficiently as possible. FIG. 8 (a) is a top view of the hand portion of the conveyance robot. FIG. 8(b) is a front view of the hand.

The shield members 18 are disposed so that the shield members 18 do not overlap the photomask 8 and do not hinder the effect of static elimination based on the upper ionizer in view from the FFU side. Moreover, the shield members 18 are formed so as to overlap first and second arms 15 and 16 of the conveyance robot 6 (in the static elimination position of the photomask 8) to prevent the lower ionizer from directly facing the FFU.

The conveyance robot 6 shown in FIG. 8 holds the photomask 8 by the first arm 15, the second arm 16 and a third arm 17. These three arms are configured so as to move in the respective directions of arrows in FIG. 8. Flanges 17 hold the photomask 8 to hang the photomask 8.

Because the three arms are formed so that the upper and lower portions of the photomask 8 except portions supported by the flanges are not covered with the three arms as sufficiently as possible, the effect of static elimination based in the ionizers can be maximized.

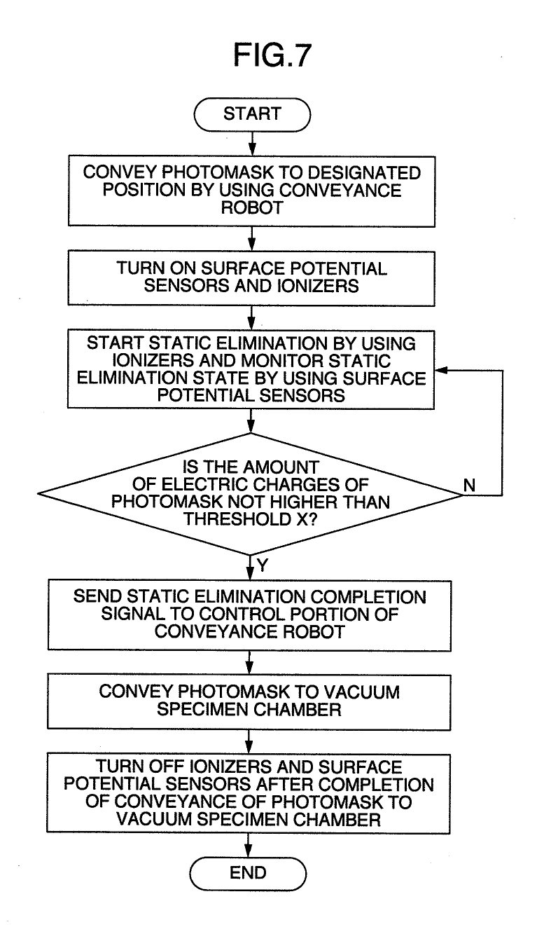

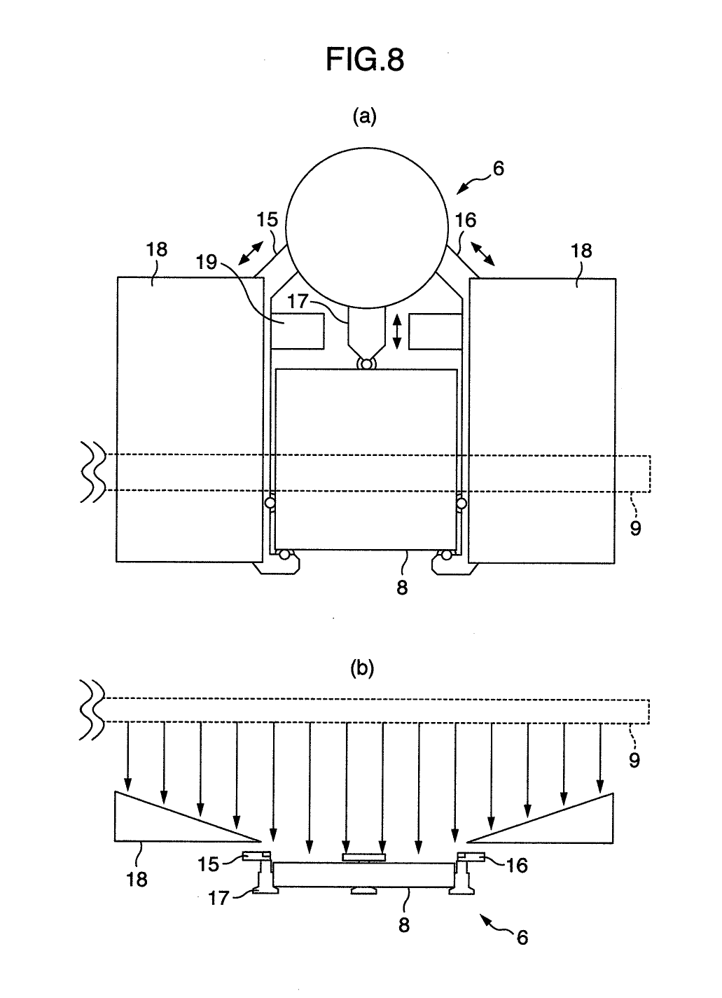

FIG. 7 shows a flow chart at the time of conveyance of the photomask 8. The conveyance robot 6 with which the front and back surfaces of the photomask 8 are not covered starts conveyance of the photomask 8 while holding the photomask 8 from the mask stocker 5. When the conveyance robot 6 has moved to a designated position in the conveyance path, the ionizers 9 are operated to start irradiation of ions. After start of the irradiation of ions, the conveyance robot 6 holding the photomask 8 moves between the ionizers 9 located above and below the conveyance path. The surface potential sensors 10 monitor static elimination and the amounts of electric charges of the photomask 8. A threshold is set for each of the surface potential sensors 10 in advance. A voltage value which does not deplete reproducibility when the length of a pattern is measured by a mask CD-SEM is set as the threshold. Each surface potential sensor 10 outputs a determination signal based on the set threshold. The determination output is sent to the control portion 13. When the determination output is not larger than the threshold, irradiation based on the ionizer 9 is not performed because there is no influence on the measurement of the pattern length. When the amount of electric charges monitored by the surface potential sensor 10 is not smaller than the threshold, the time of ion irradiation is changed and suitable ion irradiation is performed unless the amount of electric charges becomes not larger than the threshold having no influence on the measurement of the pattern length. On this occasion, when an abnormal voltage is recognized or when the time over a set maximum time of ion irradiation is recognized, alarm display of abnormality of the photomask 8 or lowering of the ion irradiation level of the ionizer 9 is provided to the operator.

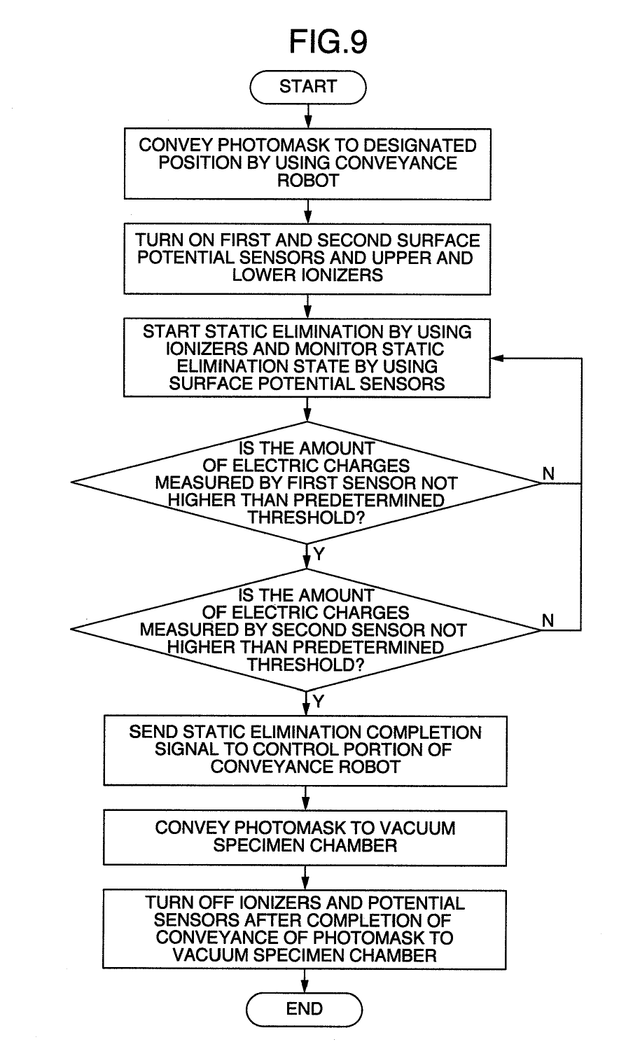

FIG. 9 is a flow chart for explaining another example of the static elimination process. This flow is the same as the flow of FIG. 7 in that a photomask is conveyed to a designated position (on a straight line connecting the two ionizers) by the conveyance robot and the ionizers are turned on in this state to start static elimination. Since the ionizers are thus turned on in the stage where the photomask has arrived at the designated position, electric charges can be eliminated from the front and back surfaces of the photomask without lowering the effect of static elimination based on the ionizer provided in the lower portion.

Although the downflow formed by the FFU acts effectively from the viewpoint that the ionizing atmosphere generated by the ionizer provided in the upper portion of the photomask is supplied to the upper surface of the photomask, the downflow is a wind unfavorable to the ionizer provided in the lower portion of the photomask. Therefore, configuration is made so that ions are emitted from the ionizer provided in the lower portion when the photomask is located in the designated position (when the downflow to the lower ionizer is blocked by the photomask) in the example described in the flow chart of FIG. 7 or 9.

Since the photomask located in the designated position serves as a downflow blocking member for the ionizer provided in the lower portion, ions can be supplied to the back surface of the photomask stably without disturbance of the ionizing atmosphere.

Since the downflow is a wind favorable to the upper ionizer supplying ions to the front surface, configuration may be made so that in order to improve static elimination efficiency, for example, the upper ionizer emits ions earlier than the lower ionizer so that the photomask can be located in the designated position after the vicinity of the photomask is changed to an ionizing atmosphere.

As described above, particularly in the case of the photomask, the amount of electric charges deposed on the back surface of the specimen may be larger than the amount of electric charges deposited on the front surface of the specimen. Conceivably, this is because the whole of the back surface is substantially made of an insulator compared with the front surface made of a chrome film or the like. Because a subject to be measured and inspected by an SEM etc. is the front surface of a specimen with a pattern formed therein, it is necessary to dispose the front surface to face an electron source side of the SEM. In static elimination only from the upper portion as described in Patent Literature 2, it is difficult to eliminate electric charges deposited on the back surface.

Moreover, in the charged corpuscular beam apparatus such as an SEM, there is used a magnetic lens or an electrostatic lens formed by a negative voltage (hereinafter also referred to as retarding voltage) applied to an objective lens or a specimen in order to converge an electron beam etc. onto the front surface of the specimen. The beam convergence state however changes when electric charges are deposited on the specimen. It has been known that suitable focusing can be performed, for example, in such a manner that the aforementioned retarding voltage is adjusted to cancel the electric charges on the front surface of the specimen.

There has been however recently found out a phenomenon that electric charges deposited on the back surface of the specimen float up to the front surface side of the specimen when the specimen is disposed on a specimen holder or a specimen stage for measurement and inspection by means of the electron beam. Such a phenomenon is particularly conspicuous in a photomask having a large amount of electric charges on the back surface of the specimen, so that there may be formed an electric charge distribution in which electric charges on the front surface of the specimen overlap electric charges on the back surface of the specimen. In order to eliminate electric charges deposited on the back surface of the specimen to thereby easily achieve adjustment of the optical condition for the SEM, the second ionizer for eliminating electric charges from the back surface of the specimen is provided so as to face the back surface of the specimen.

After static elimination based on the ionizers, the static elimination state is monitored by the surface potential sensors. Monitoring of the static elimination state is performed by use of the first surface potential sensor for measuring potential of the front surface of the photomask and the second surface potential sensor for measuring potential of the back surface of the photomask.

Since the first and second surface potential sensors are disposed between the mini-environment and the load lock chamber, the amount of electric charges after static elimination can be confirmed before the photomask is introduced into the vacuum chamber.

The flow chart in FIG. 9 explains an example in which a static elimination completion signal is sent to the control portion of the conveyance robot when each of the two amounts of electric charges measured by the two surface potential sensors is not larger than a predetermined threshold.

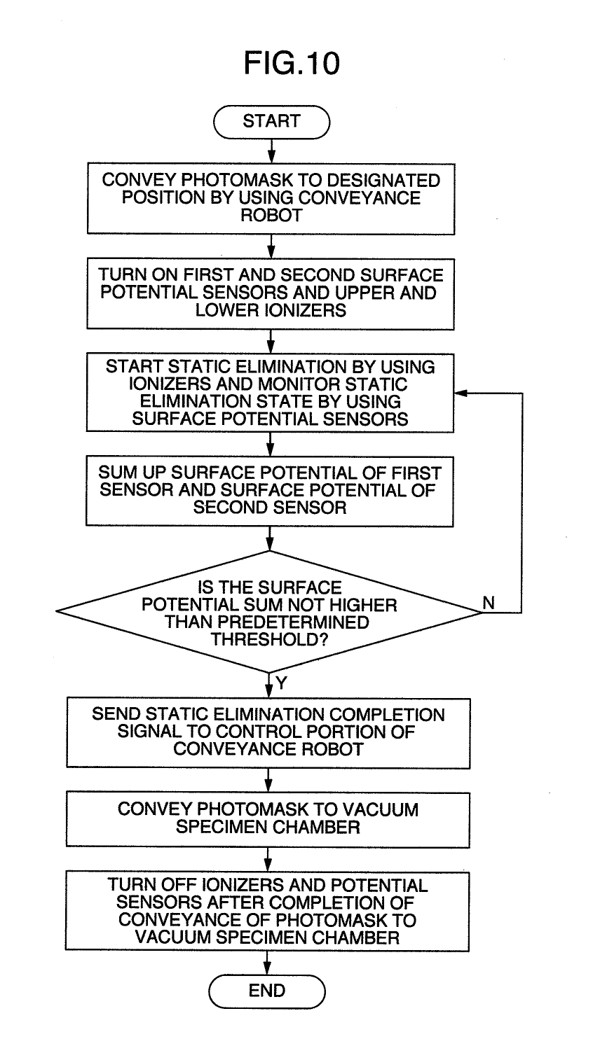

On the other hand, as described previously, a problem during measurement and inspection by means of an electron beam is static electricity formed on the front surface of the specimen. The static electricity may be a sum (Xs+Xr) of the amount of electric charges (Xs) deposited on the front surface of the specimen and the amount of electric charges (Xr) deposited on the back surface of the specimen (or may be conceivably a subtractive value in accordance with the polarity of static electricity). In this case, a threshold may be set for the sum (or subtractive value) as described in the flow chart of FIG. 10. Because it can be conceived that the electric charge amount (Xr) on the back surface of the specimen is attenuated when the electric charge amount (Xr) floats up to the front surface of the specimen, a threshold may be set in Xs+kXr in which k is an attenuation ratio. Because it can be conceived that the attenuation ratio varies according to the kind, thickness, etc. of the specimen, it is desirable that k can be adjusted.

Further, as shown in FIG. 9, control may be made in such manner that not the sum of the electric charge amounts on the front and back surfaces of the specimen but unique thresholds are set in advance for the electric charge amounts respectively so that the specimen may be controlled to be conveyed when the two electric charge amounts are not larger than the thresholds respectively. In this case, because the influence of the electric charges deposited on the back surface of the specimen, on the front surface of the specimen may vary according to the kind, thickness, etc. of the specimen, it is desirable that particularly the threshold for the back surface of the specimen can be adjusted.

As described previously, because electric charges deposited on the back surface of the specimen may be larger in amount than electric charges deposited on the front surface of the specimen, a threshold may be set only for the amount of electric charges on the back surface of the specimen so that the specimen can be conveyed when the amount of electric charges on the back surface of the specimen is not larger than the threshold.

Even in the case where two thresholds are set as shown in FIG. 9, it is desirable that the thresholds are finally decided in accordance with the magnitude of the potential generated on the front surface side of the specimen. Accordingly, for example, the threshold Xrth of the amount of electric charges on the back surface is set to satisfy the relation Xrth≦Xsrth·k in which Xsrth is the amount of electric charges on the front surface of the specimen, which can allow interference with focusing adjustment and influence on the length measurement accuracy, and k is an attenuation ratio when the electric charges on the back surface of the specimen appear on the front surface of the specimen in accordance with the specimen disposed in the specimen holder etc. If potential substantially the same as the amount of electric charges detected on the back surface of the specimen appears on the front surface of the specimen, k is 1.0. Since it can be conceived that this “k” varies according to the kind etc. of the specimen, it may be conceived that k is stored in advance in accordance with each specimen to be measured.

Multipoint measurement may be performed in order to determine whether the photomask was success or not. Since electric charges may be accumulated gradually due to irradiation of an electron beam on a specimen during the multipoint measurement, it can be conceived that a photomask is taken out once from the specimen chamber (vacuum chamber) for irradiation with the electron beam and electric charges are eliminated from the photomask by the ionizers in order to cancel the electric charges. In this case, electric charges are generated due to irradiation with the electron beam. Accordingly, a specimen surface potential measuring apparatus such as an energy filter may be used for measuring potential of each specimen surface in the specimen chamber so that static elimination can be performed by the ionizers when the potential of the specimen surface is higher than a threshold.

In order to properly eliminate electric charges from the back surface of the specimen, a gas blowout mechanism by which ions emitted from the ionizer on the back surface side of the photomask reach the back surface of the photomask with high efficiency may be provided separately from the ionizer so that ions can be introduced to the back surface of the specimen. In this case, the gas is blown out in a direction reverse to the downflow of the mini-environment. Accordingly, control may be made in such a manner that gas is blown out selectively when the photomask is positioned above the ionizer, so that ions can reach the back surface without flow disturbance of the downflow.

Moreover, in order to complete static elimination in a short time, it is desirable that static elimination is completed at once instead of repetition of measurement of the potential of the specimen and static elimination. Therefore, it may be conceived that the time (or the intensity of each ionizer) required for static elimination in the past is recorded in advance so that the time is regarded as a static elimination duration. In the case where, for example, static elimination→potential measurement→static elimination→potential measurement→ . . . are repeated, the total static elimination time is obtained by cumulatively adding up static elimination durations so that the obtained time is set as a static elimination duration for the next photomask. In this manner, the static elimination time can be shortened. Since the electric charge amounts on the front and back surfaces of the photomask may be different, it is desirable that the intensity of each ionizer is controlled in advance so that control can be made to complete elimination of electric charges from the front surface and elimination of electric charges from the back surface simultaneously.

Moreover, since it may be conceived that the amount of electric charges on the back surface of the photomask is larger, the number and intensity of ionizers disposed on the back surface side may be increased relative to those of ionizers on the front surface side of the specimen so that static elimination from the back surface of the specimen larger in the amount of electric charges can be completed at a high speed.

Since a mechanism by which the ionizer on the back surface side of the photomask moves is provided together with the conveyance arms, ions emitted from the ionizer are prevented from being blocked by the downflow while the specimen is held by the arms so that electric charges can be eliminated from the back surface of the photomask with high efficiency and static elimination can be performed by the ionizer during conveyance of the photomask into the mini-environment. Accordingly, there is an effect also in shortening the static elimination time.

### REFERENCE SIGN LIST

1 mini-environment
2 column
3 specimen observation chamber
4 load lock chamber
5 mask stocker
6 conveyance robot
7 load port
8 photomask
9 ionizer
10 surface potential sensor
11 FFU (filter fan unit)
12 electrode needle
13 control portion

1. A charged corpuscular beam apparatus comprising a vacuum specimen chamber which encloses a specimen to be irradiated with a charged corpuscular beam, a conveyance mechanism which conveys the specimen to be irradiated with the charged corpuscular beam, and an air cleaning mechanism which forms an air cleaning space during a conveyance process performed by the conveyance mechanism, characterized in that:
the air cleaning mechanism includes a filter fan unit for enhancing an inside air pressure by air introduced from the outside of the air cleaning mechanism, and first and second static elimination mechanisms provided above and below a conveyance track of the specimen and for eliminating static electricity from front and back surfaces of the specimen conveyed by the conveyance mechanism.

2. A charged corpuscular beam apparatus according to claim 1, characterized in that:
the first static elimination mechanism is disposed in an upper portion of the conveyance track of the specimen whereas the second static elimination mechanism is disposed in a lower portion of the conveyance track of the specimen.

3. A charged corpuscular beam apparatus according to claim 2, characterized in that:
the second static elimination mechanism is disposed in a position where arrival of a downflow brought by the filter fan unit is blocked by the specimen passing through the conveyance track.

4. A charged corpuscular beam apparatus according to claim 2, characterized in that:
the second static elimination mechanism is disposed so that the conveyance track of the specimen is formed on a downstream side of a downflow brought by the filter fan unit and between the filter fan unit and the second static elimination mechanism.

5. A charged corpuscular beam apparatus according to claim 2, characterized in that:
static elimination by the second static elimination mechanism is started when the specimen is positioned above the second static elimination mechanism by the conveyance mechanism.

6. A charged corpuscular beam apparatus comprising a vacuum specimen chamber which encloses a specimen to be irradiated with a charged corpuscular beam, a conveyance mechanism which conveys the specimen to be irradiated with the charged corpuscular beam, and an air cleaning mechanism which forms an air cleaning space during a conveyance process performed by the conveyance mechanism, characterized in that:
the apparatus further comprises first and second potential sensors which measure potential of a front surface of the specimen and potential of a back surface of the specimen respectively, and a control device which controls the conveyance mechanism based on results of the measurement made by the two potential sensors;
the air cleaning mechanism includes a filter fan unit for enhancing an inside air pressure by air introduced from the outside of the air cleaning mechanism, and first and second static elimination mechanisms provided above and below a conveyance track of the specimen and for eliminating static electricity from the front and back surfaces of the specimen conveyed by the conveyance mechanism, respectively; and
the control device performs control so that the specimen is conveyed to the vacuum specimen chamber when the potential measured by each of the first and second potential sensors is not higher than a threshold set for each of the first and second potential sensors.

7. A charged corpuscular beam apparatus comprising a vacuum specimen chamber which encloses a specimen to be irradiated with a charged corpuscular beam, a conveyance mechanism which conveys the specimen to be irradiated with the charged corpuscular beam, and an air cleaning mechanism which forms an air cleaning space during a conveyance process performed by the conveyance mechanism, characterized in that:
the apparatus further comprises first and second potential sensors which measure potential of a front surface of the specimen and potential of a back surface of the specimen respectively, and a control device which controls the conveyance mechanism based on results of the measurement made by the two potential sensors;
the air cleaning mechanism includes a filter fan unit for enhancing an inside air pressure by air introduced from the outside of the air cleaning mechanism, and first and second static elimination mechanisms provided above and below a conveyance track of the specimen and for eliminating static electricity from the front and back surfaces of the specimen conveyed by the conveyance mechanism, respectively; and
the control device performs control so that the specimen is conveyed to the vacuum specimen chamber when the sum of the potential measured by the first potential sensor and the potential measured by the second potential sensor is not higher than a predetermined threshold.
